(19) United States
(12) Patent Application Publication
(10) Pub. No.: US 2005/0200095 A1
(43) Pub. Date: Sep. 15, 2005

(54) Closed pneumatic leveling system

(76) Inventors: Patrick N. Hopkins, Farmington Hills, MI (US); Robert L. Phillis, Covington, OH (US)

Correspondence Address: Delphi Technologies, Inc.;Legal Staff, M/C 480-410-202, P.O. Box 5052, Troy, MI, 48007-5052, US

(21) Appl. No.: 11/070,920

(22) Filed: Mar. 3, 2005

Related U.S. Application Data
(60) Provisional application No. 60/552,317, filed on Mar. 10, 2004.

(51) Int. Cl. B60G 17/00

(52) U.S. Cl. 280/124.161; 280/124.157

(57) ABSTRACT

A suspension system including a pneumatic leveling system adapted to selectively receive and expel a fluid and a spare tire in communication with the leveling system, wherein the spare tire is adapted to provide the fluid to the leveling system.

This application claims priority from U.S. Provisional Patent App. No. 60/552,317 filed on Mar. 10, 2004, the entire contents of which are incorporated herein by reference.

### BACKGROUND

The present invention relates to pneumatic leveling systems and, more particularly, closed pneumatic leveling systems.

Some original equipment manufacturers (“OEMs”) of automotive vehicles offer air suspension leveling systems having more than one vehicle ride or “trim” height. Example trim heights include a “normal” ride height for most driving conditions, a lowered “entry” height for ease of entry and exit from the vehicle, a raised “off-road” height for increased ground clearance, and a slightly lower-than-normal “aero” height for improved fuel economy at higher speeds.

The trend toward multiple trim height suspension systems has brought about the desire for improved response times in changing from one trim height to another, especially when going from a lowered entry position back to normal ride height, and from normal ride height to a lowered Entry position. Air compressors, which provide compressed air to a pneumatic leveling system for changing trim height, are typically driven by DC motors. However, motors that are compatible with the typical OEM automotive requirements of low mass, low electrical current draw and low acoustic noise typically do not generate the air flow rates required to achieve the desired response times (preferably about 10 seconds or less) to change from one trim height to another.

The desire to achieve faster response times has led some OEM's toward several solutions, two of which require the addition of a separate component: an air pressure storage reservoir. An air reservoir can be used in conjunction with a compressor, and can be operated in parallel with the compressor in an “open” mode or in series with the compressor in a “closed” mode.

In the open mode of operation, the air reservoir is charged to a pressure higher than the maximum pressure required for the vehicle's air suspension system, and its air pressure is used in parallel to the output of the compressor to fill at least one air suspension lift device. After each trim height change, the compressor is used to “re-charge” the air reservoir to its original pressure so that it will be ready for the next required use. The source of this re-charge air is usually ambient atmosphere. This may result in relatively long operating times for the compressor (usually on the order of minutes) for each trim height change, which results in objectionable acoustic noise being generated for a corresponding period of time and drives a design requirement for a motor having a high mean time between failure (“MTBF”) rating in order to meet the vehicle's lifetime durability requirements. When air is required to be removed from the air suspension system to lower trim height, air is usually exhausted back into the atmosphere via an exhaust solenoid valve.

In the “closed” mode of operation, the air pressure from the reservoir is used to “pre-charge” the air compressor intake, resulting in pump operation at higher volumetric efficiency (“VE”), higher air flow rates, and faster trim height change response times, usually on the order of seconds. When air needs to be removed from the air suspension system to lower trim height, air flow direction is switched by means of at least one air direction valve, so that the air can be pumped out of the air suspension lift devices back into the air reservoir. In the closed mode of operation, the only air that is required to be added to the system is the air that is required to compensate for any air lost from the system due to system leaks. The air reservoir for a closed mode system does not need to be charged to a pressure higher than the maximum air pressure that will be required by the suspension system (as is the case with the open mode), because its air pressure is not used in parallel with the compressor, but rather is used in series with the compressor to pre-charge the intake side of the compressor. As the air is removed from the reservoir and pumped into the air suspension lift devices to raise the vehicle, the pressure in the reservoir decreases at a rate that is inversely proportional to the volume of the reservoir. Thus, the smaller the reservoir volume, the greater the rate of pressure decrease, and the larger the reservoir volume, the smaller the rate of pressure decrease. Conversely, as air is removed from the air suspension lift devices and pumped into the reservoir to lower the vehicle, the pressure in the reservoir increases at a rate that is inversely proportional to the volume of the reservoir. Volumetric efficiency of the compressor varies, dependent on the pressure in the reservoir. When air is being drawn out of the reservoir to supply the compressor inlet pressure, the VE is directly proportional to the reservoir pressure. When air is being pumped back into the reservoir, the VE is inversely proportional to the reservoir pressure. Thus, for a given system pneumatic volume, the larger the reservoir volume, the less the pressure will change within the reservoir during use, and the more consistent the performance will be for raising and lowering the vehicle trim heights.

Both the open and closed operating modes require the addition of an air reservoir to the vehicle's leveling sub-system. This adds not only mass (which may be significant) and cost, but also adds the considerable complication of finding enough volumetric space on the vehicle having an appropriate geometry for an air reservoir. Packaging space and mass very often come at a premium cost in vehicle designs. Similarly, additional components such as air reservoirs may cause undesireable compromises to be made in leveling system design or leveling system component packaging. Further, the vehicle manufacturer must consider the crashworthiness of the air reservoir, since it is a pressure vessel.

Accordingly, there is a need for an air reservoir for a vehicle pneumatic leveling system that is capable of providing a sufficient capacity of compressed air to facilitate rapid changes in vehicle trim modes, does not unduly add to vehicle weight or cost, and does not compromise the crashworthiness of the vehicle.

### SUMMARY

One aspect of the present invention provides a suspension system including a pneumatic leveling system adapted to selectively receive and expel a fluid and a spare tire in communication with the leveling system, wherein the spare tire is adapted to provide the fluid to the leveling system.

A second aspect of the present invention provides a pneumatic leveling system including a spare tire, a compressor having an inlet and an outlet, an inlet valve in communication with the compressor inlet, an outlet valve in communication with the compressor outlet, a pneumatic tee for connecting the inlet valve and the outlet valve to the pneumatic leveling system, a reservoir tee for connecting the inlet valve and the outlet valve to the spare tire, and a control unit for controlling the compressor, the inlet valve and the outlet valve, thereby selectively transferring a fluid between the spare tire and the pneumatic leveling system.

Another aspect of the present invention provides a suspension system including a pneumatic leveling system adapted to selectively receive and expel air, a spare tire in communication with the leveling system, wherein the spare tire is adapted to provide air to the leveling system and receive air expelled from the leveling system, and a compressor adapted to facilitate transfer of air between the leveling system and the spare tire.

Other aspects of the present invention will be apparent from the following description, the accompanying drawings and the appended claims.

### BRIEF DESCRIPTION OF THE DRAWINGS

FIG. 1 is a side elevational view of a pneumatic adapter according to one aspect of the present invention;

FIG. 2 is a side elevational view of a pneumatic adapter according to a second aspect of the present invention;

FIG. 3 is a schematic diagram of a pneumatic leveling system according to one aspect of the present invention;

FIG. 4 is a schematic diagram of a pneumatic leveling system according to a second aspect of the present invention; and

FIG. 5 is a perspective view of the pneumatic leveling system of FIG. 4 mounted on a vehicle.

### DETAILED DESCRIPTION

In the discussion that follows, like numerals are used to identify elements of like structure or function. In addition, the term “reservoir” is understood to encompass all types of air storage structures including, without limitation, accumulators.

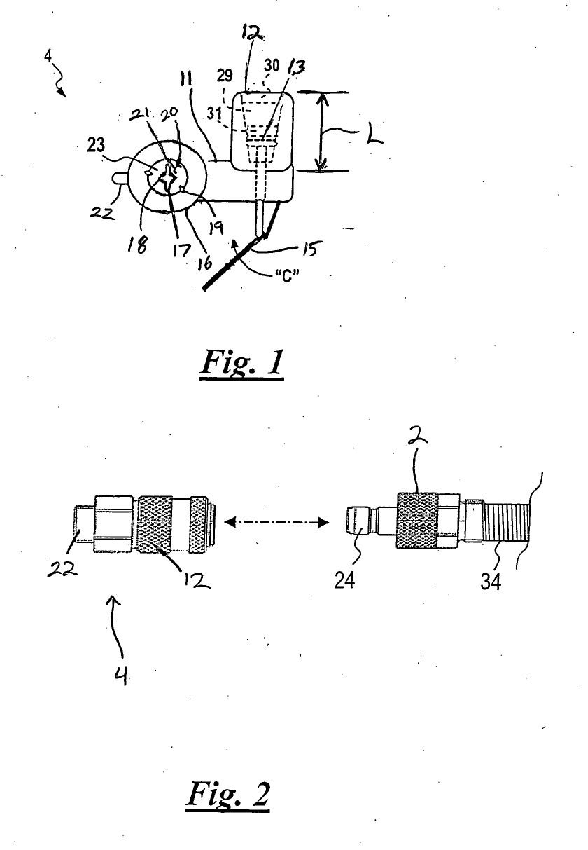

A pneumatic adapter, generally designated 4, is shown in FIG. 1 according to one aspect of the present invention. A body 11 acts as a support member to which components and features of pneumatic adapter 4 are attached. A collar 12 may be coupled to body 11 and is adapted to fit over a conventional Schrader-type tire valve 34 (see FIGS. 2, 3 and 4), the Schrader-type valve being provided without a tire valve cap. One skilled in the art will recognize that the term “Schrader-type tire valve” refers generally to the tire valve design commonly found on automotive vehicle wheels, rather than a particular source of supply. Schrader-type tire valves typically have a rubber stem, a threaded housing, and an internal, spring-loaded valve.

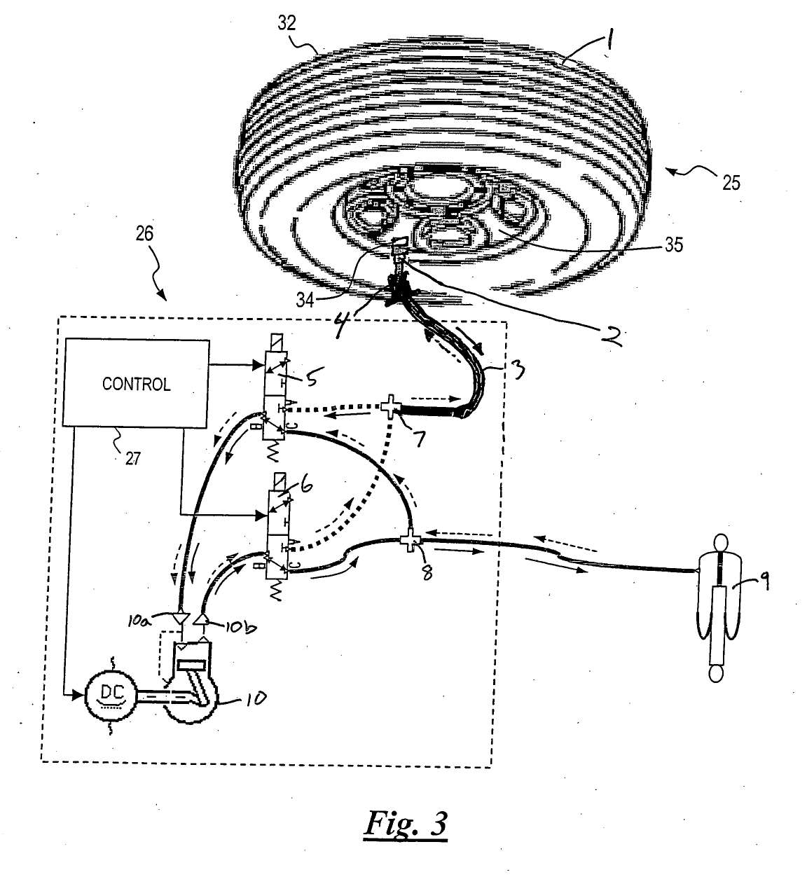

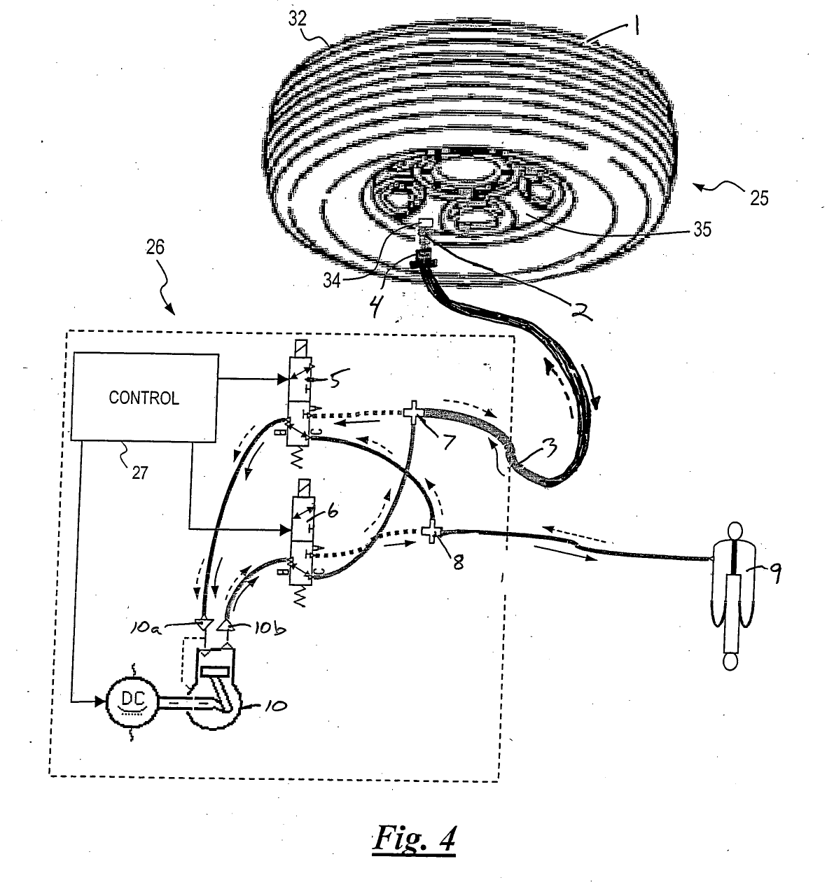

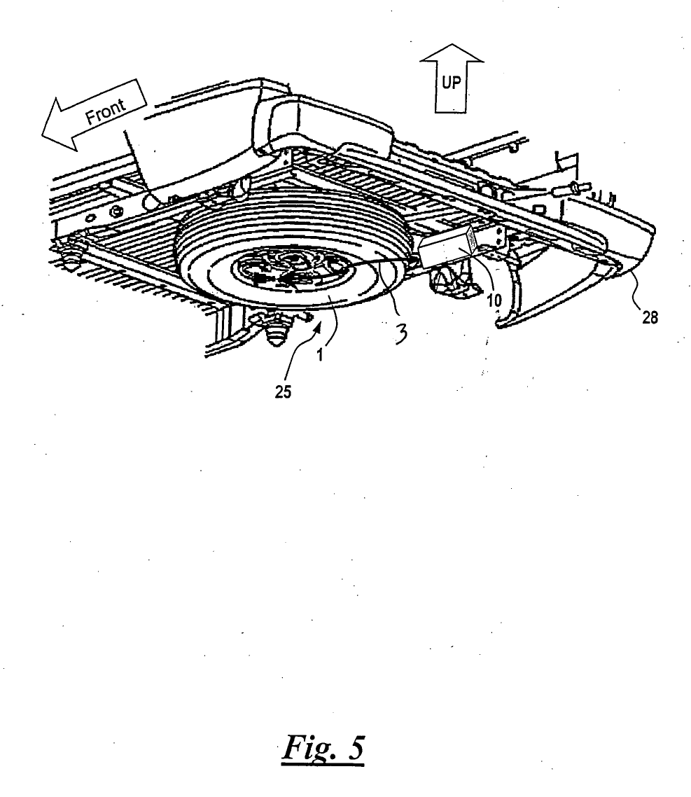

An internal surface 29 of collar 12 may be generally conical to match the external shape of Schrader-type tire valve 34 and has a length L which is adapted to minimize axial misalignment of the collar to the tire valve. Length L may be further adapted to provide adequate support to resist radial motion of pneumatic adapter 4 due to vibration imposed by an attached reservoir hose assembly 3 or an air reservoir 1 (see FIGS. 3 and 4), or a vehicle 28 to which the air reservoir is attached (see FIG. 5). Collar 12 may include an environmental seal 30 near the base of conical surface 29 to minimize contamination from outside sources. Collar 12 may further include a pneumatic seal 31 which, when pneumatic adapter 4 is fully attached to a Schrader-type tire valve 34, prevents air passage from the tire valve or air reservoir 1 (see FIG. 3) to the atmosphere. Air reservoir 1 may be a spare tire 25. The inside conical surface 29 of collar 12 may also include a core depressor 13 that is operated by an external lever 15. Core depressor 13 clamps collar 12 to the Schrader-type tire valve, thus engaging pneumatic seal 31 and physically attaching the collar to the tire valve such that the collar will remain pneumatically engaged to the tire valve, so long as lever 15 remains in its closed position.

With continued reference to FIG. 1, pneumatic adapter 4 may further include a conventional pressure relief valve 16. Pressure relief valve 16 comprises a valve portion 23 that allows air in compressor assembly 26 (see FIGS. 3 and 4) to escape if the air pressure within pneumatic adapter 4 exceeds a predetermined threshold setpoint. Valve portion 23 may be raised or lowered to a predetermined threshold air pressure setpoint by rotating the valve portion clockwise or counter-clockwise with a screwdriver inserted into a screw slot 17, or with a hex tool inserted into a hex slot 18. Once the threshold air pressure setpoint has been established, valve portion 23 may be held at the setpoint by at least one retention stake 19. A vent hole 20 provides a path for the escape of air when the threshold air pressure value has been exceeded, and a cleaner portion 21 acts to keep debris from clogging up the vent hole. A hose/tube adapter 22 may be adapted to couple pneumatic adapter 4 to a hose, such as reservoir hose 3 (see FIGS. 3 and 4).

With further reference to FIG. 1, as lever 15 is pivoted to a closed position C, the lever pushes on core depresser 13, causing the core depresser to move axially toward the base of the conical internal surface of collar 12 such that it comes in contact with, and depresses to an open position, the Schrader-type valve core stem of a Schrader-type tire valve 34 (see FIGS. 3 and 4).

An alternate aspect of pneumatic adapter 4 is depicted in FIG. 2. Pneumatic adapter 4 may be a double shut-off, quick-disconnect device and may include a collar 12 that is adapted to couple pnematically to a nipple 24 of a tire valve coupler 2. A hose/tube adapter 22 is adapted to couple pneumatic adapter 4 to a hose, such as reservoir hose 3 (see FIGS. 3 and 4). Tire valve coupler 2 may also be a double shut-off, quick disconnect device adapted to couple to pneumatic adapter 4 and a Schrader-type valve 34 of a spare tire 25 (see FIGS. 3 and 4). Alternatively, tire valve coupler 2 may be adapted to couple directly between pneumatic adapter 4 and tire 25, replacing Schrader-type valve 34.

As illustrated in FIG. 3, on aspect of the present invention may include a compressor assembly 26 having a conventional air compressor 10, an inlet valve 5, an outlet valve 6, an air reservoir tee 7, a pneumatic tee 8, reservoir hose 3 and a control unit 27, such as a programmable logic controller or a microprocessor. A spare tire assembly, generally designated 25, may include a tire 32 mounted on a wheel 35 (which together may be either a full-size or high-pressure “doughnut” type) and a Schrader-type valve 34 mounted on the wheel. Spare tire 25 may be pressurized and serve as an air reservoir 1 for a closed pneumatic leveling system 9. Leveling system 9 is pneumatically coupled to (i.e., in communication with) spare tire 25 through compressor assembly 26, using a pneumatic adapter 4 and a tire valve coupler 2 (see FIG. 2). Alternatively, a pneumatic adapter 4, as shown in FIG. 1, may be coupled to Schrader-type valve 34 of spare tire 25.

Air direction valve 5 of compressor assembly 26 serves as a compressor inlet valve. Inlet valve 5 may be connected to an inlet valve 10a of an air compressor 10. Inlet valve 5 may also be connected to air reservoir 1 via an air reservoir tee 7, reservoir hose 3, and coupling 4. Inlet valve 5 may also be connected to the pneumatic system 9 via a pneumatic tee 8. Compressor assembly 26 may further include an air direction valve 6 that serves as a compressor outlet valve. Outlet valve 6 may be coupled to an outlet valve 10b of air compressor 10. Outlet valve 6 may be connected to air reservoir 1 by an air reservoir tee 7, reservoir hose 3, pneumatic adapter 4, and tire valve coupler 2. Outlet valve 6 may also be connected to the pneumatic system 9 by a pneumatic tee 8.

In operation, control 27 may be manually or automatically signalled by an operator or by conventional sensing means (not shown) to change the trim level of the vehicle. To raise the trim level, control 27 actuates inlet valve 5 while outlet valve 6 is deactuated. Air flows from air reservoir 1 to leveling system 9 as indicated by the solid-line arrows of FIG. 3 through, in order, Schrader-type valve 34, tire valve coupler 2, pneumatic adapter 4, air reservoir hose 3, air reservoir tee 7, inlet valve 5 (in which the solenoid is displaced from the position shown in FIG. 3), compressor 10, outlet valve 6, and pneumatic tee 8. To lower the trim level, outlet valve 6 is actuated (i.e., its solenoid is displaced from the position shown in FIG. 3) while inlet valve 5 is deactuated. Consequently, air flows from pneumatic system 9 to spare tire 25 as indicated by the dashed-line arrows of FIG. 3 through, in order, pneumatic tee 8, inlet valve 5, compressor 10, outlet valve 6, air reservoir tee 7, pneumatic adapter 4, tire valve coupler 2, and Schrader-type valve 34. Compressor 10 may be actuated by control 27 to aid in the transfer of air between air reservoir 1 and pneumatic system 9.

An alternate embodiment of the present invention is depicted in FIG. 4. A compressor assembly 26 may include a conventional air compressor 10, an inlet valve 5, an outlet valve 6, an air reservoir tee 7, a pneumatic tee 8, a reservoir hose 3 and a control 27. A spare tire assembly, generally designated 25, may include a tire 32 mounted on a wheel 35 and a Schrader-type valve 34 mounted on the wheel. Spare tire 25 may be pressurized and serve as an air reservoir 1 for a closed pneumatic leveling system 9. Leveling system 9 is pneumatically coupled to spare tire 25 by compressor assembly 26, using a pneumatic adapter 4 and a tire valve coupler 2 (see FIG. 2). Alternatively, a pneumatic adapter 4 (see FIG. 1) may be coupled to Schrader-type valve 34 of spare tire 25.

Air direction valve 5 of compressor assembly 26 may serve as a compressor inlet valve. Inlet valve 5 may be coupled to an inlet valve 10a of an air compressor 10. Inlet valve 5 may also be connected to air reservoir 1 by an air reservoir tee 7, reservoir hose 3, coupling 4 and tire valve coupler 2. Inlet valve 5 may further be connected to pneumatic system 9 via a pneumatic tee 8. Compressor assembly 26 may further include an air direction valve 6 that serves as a compressor outlet valve. Outlet valve 6 may be connected to an outlet valve 10b of air compressor 10. Outlet valve 6 may also be connected to air reservoir 1 by an air reservoir tee 7, reservoir hose 3, pneumatic adapter 4 and tire valve coupler 2. Outlet valve 6 may also be connected to the pneumatic system 9 via pneumatic tee 8.

In operation, control 27 may be manually or automatically signalled by an operator or by conventional sensing means (not shown) to change the trim level of the vehicle. To raise the trim level, control 27 actuates both inlet valve 5 and outlet valve 6, thereby displacing their respective solenoids from the positions shown in the drawing. Air flows from air reservoir 1 to leveling system 9 as indicated by the solid-line arrows of FIG. 4 through, in order, Schrader-type valve 34, tire valve coupler 2, pneumatic adapter 4, reservoir hose 3, air reservoir tee 7, inlet valve 5, compressor 10, outlet valve 6 and pneumatic tee 8. To lower the trim level, both inlet valve 5 and outlet valve 6 are deactuated. Air flows from pneumatic system 9 to spare tire 25 as indicated by the dashed-line arrows of FIG. 4 through, in order, pneumatic tee 8, inlet valve 5, compressor 10, outlet valve 6, air reservoir tee 7, pneumatic adapter 4, tire valve coupler 2 and Schrader-type valve 34. Compressor 10 is actuated by control 27 to aid in the transfer of air between air reservoir 1 and pneumatic system 9. Either inlet valve 5 or outlet valve 6 may be actuated to prevent air from passing from pneumatic system 9 to air reservoir 1, thus maintaining a selected trim level of the pneumatic system.

A typical spare tire 25 has an internal pneumatic volume of about 60 to 90 liters, depending upon size, whereas a typical separately-packaged air reservoir may typically be in about the 6 to 14 liter volume range. In terms of control of the trim level, such as between the two functions of raising the vehicle from a lowered position and lowering the vehicle from a raised position, it may be preferable to give higher priority to lowering the vehicle from a raised position, since a lower center of gravity produces a more stable condition in terms of vehicle dynamics.

With reference to FIGS. 1-5, advantages of the present invention include a reduction of component mass and cost associated with a closed vehicle pneumatic leveling system, as well as the fact that most vehicles already have the component packaging for an air reservoir in the form of a pressurized spare tire 25. Other advantages include, but are not limited to:

1. More consistent leveling system 9 performance;

2. The potential to reduce the response time required to lower the vehicle, in the case of a multiple trim height suspension system, from one target trim height to a lower target trim height, such as normal to entry mode, or off-road to normal mode;

3. Crashworthiness—adding a separate pressurized air reservoir raises additional crash protection and testing concerns. This concern is eliminated by the present invention, as the crashworthiness of spare tire 25 has already been considered during vehicle design and is not significantly impacted by the present invention;

4. Spare tire pressure—it is not uncommon for the air pressure in spare tire 25 to go unchecked for years. If the owner ever does need the spare, he or she is likely to find it under-inflated. The present invention will maintain spare tire 25 inflation within a predetermined pressure range, and the system may be further adapted to adjust the spare tire to an optimal pressure on manual or automatic command. In a further embodiment of the present invention, the valve stem (not shown) and Schrader-type valve 34 could be removed from wheel 35 (see FIGS. 3 and 4) and replaced by tire valve coupler 2. However, if a new spare tire must be mounted on the wheel, a service facility would need a special adapter to inflate the tire and seat the beads of tire 32;

5. An alternate embodiment of the present invention comprises a pneumatic leveling system 9 wherein the vehicle owner may lower the pressure of the vehicle's tires to a lower value for off-road use and then use the pneumatic leveling system to re-inflate the tires to a higher pressure for on-road use. If compressor assembly 26 allows compressor 10 to draw air from reservoir 1 instead of atmospheric air, inflation speed is greatly increased while the stress on the compressor is greatly reduced. A small reservoir common in the art, sized for leveling system 9, would provide only a limited “boost” for inflating just the first tire or so. However, the substantial reservoir volume of a full-size spare tire 25 will be of assistance for at least a portion of the four in-service tires of the vehicle, depending on the spare tire pressure and volume;

6. It is less expensive to tool a new double shut-off quick connect tire valve coupler 2, in accordance with an embodiment of the present invention, than it would be to tool a new, uniquely shaped air reservoir and associated mounting hardware. This is a particular advantage for an optional equipment system or a vehicle having a low production volume;

7. The double shut-off feature of the pneumatic connection 4, 2 (FIG. 2) prevents air from escaping from either spare tire 25 reservoir 1 or leveling system 9 whenever hose 3 is disconnected; and

8. The quick-connect feature of the pneumatic connection 4, 2 (FIG. 2) allows for easier connection on the OEM vehicle assembly line and easier disconnection when air reservoir 1 must be used as a spare tire.

Although the invention is shown and described with respect to certain embodiments, it is obvious that equivalents and modifications will occur to those skilled in the art upon reading and understanding the specification. The present invention includes all such equivalents and modifications and is limited only by the scope of the claims.

1. A suspension system comprising:
a pneumatic leveling system adapted to selectively receive and expel a fluid; and
a spare tire in communication with said leveling system, wherein said spare tire is adapted to provide said fluid to said leveling system.

2. The suspension system of claim 1 wherein said fluid is air.

3. The suspension system of claim 1 wherein said spare tire is adapted to receive said fluid expelled from said leveling system.

4. The suspension system of claim 3 further comprising a compressor, wherein said compressor is adapted to facilitate transfer of said fluid between said leveling system and said spare tire.

5. The suspension system of claim 1 further comprising a control unit for controlling a flow of said fluid between said spare tire and said leveling system.

6. The suspension system of claim 1 wherein said spare tire includes a Schrader-type valve.

7. The suspension system of claim 6 further comprising a pneumatic adapter having a collar for engaging said Schrader-type valve.

8. The suspension system of claim 1 further comprising a pneumatic adapter for connecting said leveling system to said spare tire.

9. The suspension system of claim 8 wherein said pneumatic adapter includes a pressure relief valve.

10. The suspension system of claim 8 wherein said pneumatic adapter is a double shut-off quick disconnect device.

11. The suspension system of claim 1 wherein said leveling system receives said fluid to raise a vehicle ride height and expels said fluid to lower said vehicle ride height.

12. The suspension system of claim 1 further comprising:
an air compressor having an inlet and an outlet;
an inlet valve in communication with said compressor inlet;
an outlet valve in communication with said compressor outlet;
a pneumatic tee for connecting said inlet valve and said outlet valve to said leveling system;
a reservoir tee for connecting said inlet valve and said outlet valve to said spare tire; and
a control unit for controlling said compressor, said inlet valve and said outlet valve, thereby selectively transferring said fluid between said spare tire and said leveling system.

14. A vehicle including the suspension system of claim 1.

15. A pneumatic leveling system comprising:
a spare tire;
a compressor having an inlet and an outlet;
an inlet valve in communication with said compressor inlet;
an outlet valve in communication with said compressor outlet;
a pneumatic tee for connecting said inlet valve and said outlet valve to said pneumatic leveling system;
a reservoir tee for connecting said inlet valve and said outlet valve to said spare tire; and
a control unit for controlling said compressor, said inlet valve and said outlet valve, thereby selectively transferring a fluid between said spare tire and said pneumatic leveling system.

16. The system of claim 15 wherein said fluid is air.

17. The system of claim 15 wherein said spare tire is connected to said reservoir tee by a pneumatic adapter.

18. The system of claim 15 wherein said fluid is introduced into said pneumatic leveling system to increase a vehicle ride height and said fluid is removed from said pneumatic leveling system to decrease said vehicle ride height.

19. The system of claim 15 wherein said spare tire and said compressor are mounted to a vehicle.

20. A suspension system comprising:
a pneumatic leveling system adapted to selectively receive and expel air;
a spare tire in communication with said leveling system, wherein said spare tire is adapted to provide said air to said leveling system and receive said air expelled from said leveling system; and
a compressor adapted to facilitate transfer of said air between said leveling system and said spare tire.
